(19) United States
(12) Patent Application Publication
(10) Pub. No.: US 2006/0274045 A1
(43) Pub. Date: Dec. 7, 2006

(54) Ergonomic keyboard systems and methods

(76) Inventor: Scott Stenbroten, Madison, WI (US)

Correspondence Address: Medlen & Carroll, LLP, Suite 350, 101 Howard Street, San Francisco, CA, 94105, US

(21) Appl. No.: 11/435,918

(22) Filed: May 17, 2006

Related U.S. Application Data
(60) Provisional application No. 60/681,813, filed on May 17, 2005.
(60) Provisional application No. 60/710,745, filed on Aug. 24, 2005.
(60) Provisional application No. 60/748,991, filed on Dec. 9, 2005.

(51) Int. Cl. G09G 5/00

(52) U.S. Cl. 345/168

(57) ABSTRACT

The present invention provides ergonomic keyboards and methods of using such keyboards. In particular, the present invention provides split keyboards for use on non-traditional surfaces such as body parts and provides keyboard components having one or more additional non-keyboard functionalities (e.g., point-and-click capabilities).

The present invention claims priority to U.S. Provisional Patent Application Ser. Nos. 60/681,813, filed May 17, 2005, 60/710,745, filed Aug. 24, 2005, and 60/748,991, filed Dec. 9, 2005, each of which is herein incorporated by references in their entireties.

### FIELD OF THE INVENTION

The present invention provides ergonomic keyboards and methods of using such keyboards. In particular, the present invention provides split keyboards for use on non-traditional surfaces such as body parts and provides keyboard components having one or more additional non-keyboard functionalities (e.g., point-and-click capabilities).

### BACKGROUND OF THE INVENTION

For many people, using computers is physically uncomfortable. Many people suffer back, neck, elbow, and wrist pain and injuries due to using a keyboard and mouse. Most computer keyboards force users to keep their hands, wrists, arms, shoulders, etc. in the same locked position, often causing users fatigue and injury. Keyboard trays that extend from under a tabletop restrict and cramp the user's legs. Even with the finest ergonomic chairs, adjusted to the perfect height and tilt, allowing users to sit at the keyboard and mouse and have them adjusted to fit in what is considered to be an ideal typing position, computer users are still very restricted in posture and forced to sit with their arms locked in one position.

Because not having enough space on a desktop can be a problem, many people have computer trays that allow the keyboard to extend out from under a desk or tabletop. But these restrict leg movements and limit the ability of users to cross their legs or prop them on footstools. Thus, what is needed are improved computer systems and methods that allow users to have greater control and flexibility in their body positions.

### BRIEF DESCRIPTION OF THE DRAWINGS

FIG. 1 shows a keyboard/mouse device for use by the right hand in some embodiments of the present invention.

FIG. 2 shows the left and right hand portions of a device in one embodiment of the present invention.

FIG. 3 shows the undersides of the left and right hand portions of a device in one embodiment of the present invention.

FIG. 4 shows devices of the present invention in use in an ergonomically correct posture in some embodiments of the present invention.

FIG. 5 shows both left and right hand device units in use in one embodiment of the present invention.

FIG. 6 shows both left and right hand device units in use in various embodiments of the present invention.

FIG. 7 shows both left and right hand device units in use in various embodiments of the present invention.

FIG. 8 shows the invention suspended from a hook for storage purposes.

FIG. 9 shows both left and right hand device units in use in various embodiments of the present invention.

FIG. 10 shows both left and right hand device units in use in various embodiments of the present invention.

FIG. 11 shows both left and right hand device units in use in various embodiments of the present invention.

FIG. 12 shows both left and right hand device units in use in various embodiments of the present invention.

FIG. 13 shows both left and right hand device units in use in various embodiments of the present invention.

FIG. 14 shows both left and right hand device units in use in various embodiments of the present invention.

FIG. 15 shows both left and right hand device units in use in various embodiments of the present invention.

FIG. 16 shows input device platforms in use in various embodiments of the present invention.

FIG. 17 shows input device platforms, wrist rests, and cable management systems in use in various embodiments of the present invention.

### SUMMARY OF THE INVENTION

The present invention provides ergonomic keyboards and methods of using such keyboards. In particular, the present invention provides split keyboards for use on non-traditional surfaces such as body parts and provides keyboard components having one or more additional non-keyboard functionalities (e.g., point-and-click capabilities). These systems and methods solve many problems associated with the more ergonomically limited systems and methods currently in use.

Instead of forcing the person to adapt their posture to the keyboard, the present invention adapts the keyboard to the person's posture and arm position allowing the user to sit more comfortably and in many more positions. The present invention allows the computer user to achieve an ergonomically correct typing position in many more environments than standard keyboards and mouse. In some preferred embodiments, the present invention combines the keyboard and mouse together, eliminating the need to have to reach for the mouse and helping to eliminate repetitive motion or other afflictions relating to its use. The present invention also allows its user to keep the desktop clear without the need of a special desk or computer tray. In some preferred embodiments, the present invention provides redundancy of functions (e.g., mouse functions, scrolling, clicking, etc.) to allow the user a diverse set of hand positions that can be altered over time to reduce repetitive stress.

A very common problem related to the use of computers is stress and strain arising from the need of the typist to adopt a relatively stationary, often erect and rigid posture when touch typing. Different types of keyboards and pointing devices have been designed to minimize these problems, but none of them address the fundamental issues relating to a person having to sit in one position doing repetitive movements for long periods of time. There is a need for a computer keyboard and mouse to allow a person more flexibility and the ability to change positions while using a computer. Instead of a person's body having to conform to a computer keyboard the computer keyboard should conform to the human body allowing a person to constantly make changes to there posture while they use a computer. The present invention meets this need.

In particular, the present invention provides a keyboard configured for use on non-traditional surfaces, such as the user's lap, arm chairs, open air, etc. The present invention accomplishes this, in some embodiments, by providing a split keyboard for separate use by the right and left hands, wherein each portion of the keyboard is configured to rest on and move on shapes such as legs, chair arms, etc. and wherein the portions have a region that locks onto (e.g., firmly or loosely) or is in contact with the user's hand or arms to permit the user to freely move the device along a plane or in three-dimensional space.

The present invention liberates the computer user from having to sit with their arms and body locked to a tabletop, desk or tray. In preferred embodiments, it combines the mouse with a keyboard and puts them on a frame that floats on the top of a persons leg, making computer use physically more natural and relaxing, helping to eliminate fatigue and injuries related to both computer keyboard use and mouse use, offering people like police officers using computers in cars or others who type in ergonomically unfriendly environments a more comfortable, easy-to-use, and healthy option. In some embodiments, a split computer keyboard, mouse and touch pad combination are made to be used on a person's legs for better mobility and more posture options.

It is to be understood that the devices of the present invention are not limited to traditional computer keyboard functions, and that any button shape, size, quantity, or configuration may be used. For example, in some embodiments, the devices enable consumer service like credit card magnetic strip reading, military applications, automobile, aircraft, boat operation etc. In some embodiments, the devices of the present invention do not provide a keyboard function (e.g., providing mouse functions only or other computer peripheral functions).

In preferred embodiments, various of the hardware components of device of the present invention are configured to maximize the ability to change typing positions or styles over time to minimize repetitive stress injuries, soreness, etc. Thus, in some embodiments, multiple components are provided with redundant features to allow the user to switch from one to another over time to permit a change in hand, wrist, arm, or other body positions. Additionally, components may be separable to allow different attachment positions and/or the addition of different components to change the shape and position of the device. Software may also be employed to change the function of particular buttons or other components over time. In some embodiments, software allows the user to have control over the individual elements, properties, and or options. For instance one option allows the user to set the pointing arrow for the mouse to a different speed then that of the touchpad, allowing the user to have “quick” and “slow” cursor movement options available all the time.

In some embodiments of the invention, a frame or housing supports a computer keyboard and mouse. In some embodiments, the underside of the frame is shaped so that it can rest and move smoothly on a leg or in a lap or on other non-traditional surfaces (e.g., surfaces other than a desk or keyboard tray). For example, the base of the keyboard is fitted with a form that fits or grasps the users hand when using the mouse. For example, in some preferred embodiments, the mouse component is configured to be in line with the hand and arm, such that the users hand can grip the mouse in an ergonomic manner without the need to twist or bend the wrist when using the mouse. A mouse or a motion sensing LED is located under this form or under the keyboard. This configuration allows the computer user to achieve an ergonomically correct typing position in many more environments than standard keyboards; it does not rely upon special chairs, trays or desks. This allows the user to sit naturally and change posture with great ease and flexibility while continuing to type and use the mouse, allowing the user to sit in positions recognized for their ergonomic benefits as well as positions associated with relaxation without having to adjust a computer tray or a chair. By combining the mouse and keyboard into a single unit the user is able to switch between typing and using the mouse by, for example, simply dropping the palm of their hand on top of a control panel, button, or other component that triggers a mouse click or other desired control feature. Taking away the need to reach for a mouse helps to eliminate repetitive stress injuries related mouse use.

In some embodiments, the keyboard button pad is on a curved surface to allow access to the keys with minimal movement of the hands. In some embodiments, the computer keyboard or the surface that holds it has a wave shape for ease of grip. In some embodiments, the device has a palm rest and or cushioned area.

In some embodiments of the invention, pressing down the palm area of the mouse form activates the left click function of the mouse. This palm-activated switch may be pressure sensitive allowing the palm to rest on it without triggering it and allowing a slight intentional movement of the palm to trigger the switch. In some preferred embodiments, the right, left click, and scroll wheel controls are also located above the top rows of the keyboards. In some embodiments these controls can be located next to the lower portion, or on either side of the keyboard or mouse. In some embodiments, the form used when operating mouse function is gripped by opening the hand up and extending the outer fingers. In some embodiments of the invention, the mouse portion is shaped and gripped similar to a traditional mouse. In some embodiments, the area used to grip the mouse is in a shape that fits the shape of the fingers as they are moved from the typing position to the mouse position. In some embodiments, the mouse detaches from keyboard section. In some embodiments of the invention, either left or right hand mouse is fitted with an on/off switch and or adjustments for speed of motion sensor. In some embodiments, the height and or angle of the mouse can be adjusted.

In some embodiments, the mouse is activated by pressing down on a form that engages it. This action allows the user to easily activate and deactivate the mouse, allowing movement of the mouse without moving the pointer. This makes its use on a small surface area like a leg more practical. A traditional mouse must be physically grasped and lifted in order to reposition it without moving the cursor. Now the user is able to keep their fingers on the keyboard and by simply lowering and raising their palm onto a form, they are able to control the mouse function for maximum economy of motion and comfort. This function can be accomplished by a flexible form that has a memory allowing it to be pressed upon engaging the mouse with a surface and when released springing the mouse or portion of it off the surface. This process can also be reversed where pressing down deactivates the mouse and releasing or taking a hand off the rest activates it. This device and these functions can be used on any surface including a leg. These functions can also be accomplished by a switch, a button, an infra-red camera, or similar sensor.

In some embodiments, the housing that covers the mouse (that the hand rests on to guide it) can be pressed down to activate the left and or right click functions of the mouse.

In some embodiments, a mouse pad, cloth or cape may be used to drape over the leg for ease in operation of the mouse function. In some embodiments, this cape may be attached with Velcro, a hook and or other temporary method that allows the device to easily grab hold of it when it is being transported off the user's leg. This cape may have a strap or a hole in it allowing the user to easily store or hang it with the device. In some embodiments, the cape is of sufficient size and shape to form a carrying case or bag that houses the keyboard or keyboard component. In some embodiments, the keyboard component has an inner chamber that allows for storage of the cape (or other components) should the user wish not to have them exposed during use of the keyboard.

In some preferred embodiments a scroll wheel is located near the base of the keyboard so as to allow a thumb to use the scroll wheel while the hand is in a typing position or substantially in a typing position. To facilitate use, the scroll wheel may be positioned perpendicular to the arm, allowing the thumb to turn the wheel by moving side-to-side while the hand is in a typing position. In other embodiments, the scroll wheel is parallel to the arm or positioned or positionable at an angle between perpendicular and parallel. In some embodiments, two or more scroll wheels are provided (e.g., controlling horizontal and vertical movement of a cursor). In some preferred embodiments, a first scroll wheel is provided on a first split keyboard component (e.g., right hand) and a second scroll wheel is provided on a second split keyboard component (e.g., left hand).

In some preferred embodiments a button is position near and/or along the side of the keyboard so as to allow a thumb to activate the button while the hand is in a typing position or substantially in a typing position. The button may be used as a standard “right-click” or “left-click” mouse function or any other desired function. In some embodiments, two or more such buttons are provided, for example, on separate split keyboard components.

In some embodiments of the invention, the undercarriage is made to work on a smooth surface like a desk or tray while further being configured to work on a person's leg or in their lap. This allows the user to switch to either method depending upon their preference.

In some embodiments of the invention, the keyboard system may use a docking station that sits, for example, on top of a surface like a desk. The docking station may be configured to allow user to operate all functions of keyboard, when associated with the docking station. The docking station may also serve as a receiver for wireless signals with or without battery charging abilities to permit the docking station to communicate with the keyboard/mouse components and/or to other peripherals.

In some embodiments of the invention, the undercarriage is adjustable to fit a variety of shapes and sizes of legs or other surfaces. For example, in some embodiments, adjustments are made with any known techniques including mechanical levers, sliders, inflatable pieces, etc. Portions of the device can also be adjusted using Velcro or other fasteners. One skilled in the art will appreciate a wide variety of options for carrying out this aspect of the invention. In some embodiments, the undercarriage contracts and restricts, fitting the shape of the user's leg and its varying dimensions. In some embodiments, the undercarriage may be configured with a variety of differently shaped handles, inflatable components (e.g., inflatable with air, water, etc.), or other components to enhance use and comfort. In some embodiments of the invention, a retractable anchoring device is used to anchor the device to the body or clothing while allowing enough mobility to operate the mouse function. This device may be similar to a retractable key chain and may attach in any variety of ways related to this concept. The tension of this device may be adjustable. In some embodiments the device can hang from the user's mid section by a retractable key chain or retractable badge type device. This retractable stabilizer tightly holds the device when legs are at an angle and also when the device is pulled up closer to user's mid section allowing the user to easily stand, move, or change positions without taking off or holding device and still allow movements needed for use of the mouse.

In some embodiments of the invention, the undercarriage that holds device in place is interchangeable with different styles, shapes, sizes and material options and or different forms to fit a variety of leg sizes or mounting surfaces. These interchangeable forms may be cosmetic in nature and used as decorative enhancement. In some embodiments, the entire undercarriage rotates to allow further adjustment. In some embodiments of the invention, the undercarriage grips tight enough to allow user to stand or walk while device is attached to legs (e.g., while still allowing lateral motion to operate the mouse function and/or to adjust position for variation in the ergonomic usage). In some embodiments, the device contains a connector that allows attachment to a belt, pocket, or component of a user's clothing so that the device may be easily transported and/or use in a walking position. In some embodiments, a retractable stabilizing system is used to give the user complete three-dimensional mobility up and down, side by side and in between, allowing the user to type while sitting, laying or standing. For example, giving the user the ability to type in the same position as a gunslinger preparing to draw from a two-gun holster and easily sit down and type more conventionally. In one embodiment the retractable stabilizing system is a belt, suspender, and or harness-based system.

In some embodiments, an anchoring mechanism is added that anchors or grips the device to a leg or other surface. This mechanism may be hinged or made in such a way that it can be disengaged easily in order to allow the device free movement.

In some embodiments, the underside of one of the keyboard trays is fitted with forms or edges that hold the device steady and are adjustable to a leg. These forms or part of these forms, are made of a material that is not conducive to sliding or creates enough friction to keep the device from moving. This holds the device in place allowing the leg to attain many different postures. In some embodiments, a mouse pad rests on a user's leg facilitating use of a keyboard with a built in mouse.

In some embodiments, the left hand device is made to be stationary on the left leg, while the right hand device is made to be easily moved to allow use of built in mouse or pointing device. This right hand device can be fitted with a form that may be hinged to allow the user to engage it on a leg in order to anchor it to a leg and easily disengaged for movement. The same configuration may be applied to the left hand portion or to both.

In some embodiments, both devices are made to be stationary and or without movement during use. These devices might have one or more pointing mechanism like a touchpad and or infrared sensor and or camera to sense movement.

In some embodiments, the invention is gripped by slipping a thumb, finger, fingers, hand, wrist, and/or portion of an arm into, onto or around a form/forms or a bowling ball type grip and or a honeycomb type grip, slot/groove/pocket. This grip may have several different openings that allow the hand control of movement of the device and or the pointing operation of a built in computer mouse. This allows the hand to grip from different positions or angles, therefore minimizing repetitive stress related problems and accommodating different hand sizes. Gripping areas may be as simple as a small panel that a finger/thumb etc . . . may ride against. These forms or grips may be adjustable, having the ability to slide or be moved into different angles, positions, or directions allowing them to better accommodate different hand shapes and sizes. These grips or forms may also be used to lift, carry and or move device.

In some embodiments of the invention, the portion of the device that grips the user's hand is interchangeable with different styles, shapes, sizes and material options. In some embodiments, the entire frame is one piece. In some embodiments, the portion of the device that grips the user's hand is adjustable to fit various hand sizes by, for example, using mechanical means or by being made of material that is rigid enough to grip, but soft enough to bend to fit larger or smaller hands. In some embodiments, the portion of the device that grips the user's hand wraps around the hand or wrist such that the keyboard component moves with the hand in three-dimensional space without falling off or otherwise disengaging from the hand. In some embodiments, a handle used to manipulate the device and operate the mouse is located above the top row of the keys.

In some embodiments of the invention, both left and right hand elements are foldable or otherwise attachable into one piece or are otherwise made to be very compact and mobile to allow ease of transport and or storage. In some embodiments of the invention, the system is disassembled and put back together for ease of transport, storage, cleaning etc. In some embodiments of the invention, the two keyboard components can be joined together and used as a one piece unit and easily taken apart to be used as a split keyboard.

In some embodiments the user is able to choose which components he wants. Because components are easily mixed and matched, the use has the option to add additional components in the future. For example, one user may want a mouse on both left and right hand sides while another user may choose not to have a mouse at all, knowing that it can always be added later if necessary.

In some embodiments of the invention, a joystick and or other game or gaming controls are incorporated onto one or both split keyboard components. In some embodiments, the keyboard is augmented with gaming controls directly in the keys. In some embodiments, the invention is exclusively for gaming and incorporates functions and controls used with gaming.

In some embodiments of the invention, all components including frame, mouse, keyboard, handles, forms, buttons etc. are supplied separately and the user is as able to assemble and disassemble various components or be able to replace broken or worn parts.

In some embodiments of the invention, the device is made to accept aftermarket components allowing the user to switch out and use different manufacturers' equipment.

In some embodiments, keyboards with other key functions like numbers, Internet and/or multimedia hotkeys can be used in conjunction with this device. In some embodiments, deployment of additional keyboards is as simple as placing another smaller keyboard on top of the right or left hand keyboard. The device may also have a retractable tray that allows alternative keyboards to be pulled out over the preexisting keyboard. In alternative embodiments, a portion of the device may be folded out accordion style, rolled out, or may be permanently attached in and around the regular keyboard. In some embodiments, it may be a virtual keyboard that is projected. In some embodiments, the auxiliary keyboard is physically under the standard keyboard and accessed by opening like a “makeup compact.” Software settings may be used to permit the processor receiving the signals from the keyboard to understand which characters correlate to which keypad set. In some embodiments the keyboard is contoured with the keys set into wells and molded to fit the natural contours of the fingers. In some embodiments additional keyboards or writing pads may be hinged in order to allow the user to flip them into a usable position and easily flip them out of the way.

In some embodiments the pc board and/or other electronic components are located on the outside edge or edges of the keyboard device. In some embodiments of the invention, the pc board and other electronic components are located underneath the keyboard device. In preferred embodiments, the electronic components are located inside a central region of the device.

In some embodiments, keyboard height and or angle can be adjusted.

In some embodiments, the keyboard is fitted with an internal or external device allowing it to be switched between several computers for those who work on several computers at one time. In other embodiments, software and/or hardware give the device the ability to switch between operation of more than one computer.

In some embodiments of the invention, a braking mechanism is used to stop the device from moving while it is being typed on. In some embodiments, the braking function is disabled when using the mouse function. In some embodiments, the braking function can be controlled by a variety of electronic or mechanical methods including a simple button or switch that disengages the braking, or a mechanism that is triggered when a hand is placed in position to use the mouse, or a device that disengages when device is moved or pushed in a certain direction.

In some embodiments strips of foam or functionally similar components are positioned on the undercarriage to help keep the device from sliding. In some embodiment these strips are in various shapes, sizes, and thicknesses. In some embodiment the foam strips are attached with Velcro. In some embodiment several strips are stored in or on the device allowing the user easy access to them. In some embodiments any material may be used in place of foam or Velcro.

In some embodiments the device is weighted in order to keep the device balanced. For example an additional keyboard or mouse may be added to one side of the device. The weight of this addition makes the device pull to one side. By adding weight to the other side the device becomes more stable and easier to use. In some embodiment weighted strips can be easily positioned upon the device to promote balance. In some embodiment these weights are attached with Velcro.

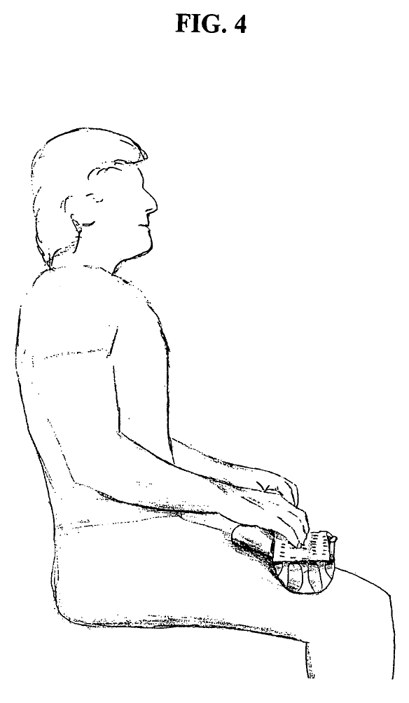

In some embodiments the device is used on a table top. In some embodiments, this is done by removing the edges (e.g., FIG. 3: 4,5,7) and adjusting the angle of the mouse. By simply re-attaching the edges and adjusting the mouse the user can easily use the device on his legs. The user may want to mark the position of the edges to aid in this process.

In some embodiments, wireless connections are incorporated. In some embodiments, solar powered battery recharging systems are used.

In some embodiments of the invention, one or more input devices such as touchpads, trackballs, and/or pointers are used in place of a mouse or incorporated along with the mouse. In other embodiments, there are one or more touchpads, trackballs, and/or pointers without the mouse feature. In some embodiments, a mouse, touchpad, trackball, or pointer has a detached scroll wheel and or right and left click buttons that can be placed in different positions. In some embodiments, the device is made to have the various elements like touchpad, mouse, scroll wheel, grips, skis, sliders, any and all elements may be moved or adjusted to aid in the user being able to fit the device to their physical and/or environmental requirements.

In some embodiments, one or more platforms attached or connected to one or more keyboard devices are used to position one or more input devices for use by the user. Such input devices may include, but are not limited to, touchpads, pointers, mice, trackballs, scroll wheels, buttons, number pads, keypads, tablets, or other devices. By positioning such devices in different places, the user is able to minimize the distance that the user's hands have to move to operate pointing, clicking, scrolling, and similar functions. In some cases, users may operate the touchpad without having to move their hands from the typing position. The platforms also enable people who are left handed to use equipment made for right handed people, and vice versa. Multiple platforms may be used with multiple input devices to provide more functionality for the user than would be available with a conventional input device arrangement (e.g., a standard keyboard and mouse). For example, the present invention allows the simultaneous use of multiple input devices that are optimized for different and/or specialized functions (e.g., different cursor tracking speeds or types of movements). In other embodiments, multiple identical input devices may be used to provide redundancy and to allow different hand and finger movements to accomplish the same functions (e.g., to prevent repetitive stress injuries). In preferred embodiments, the arrangement of input devices is fully customizable to optimize both comfort and functionality for the user. The present invention allows a wide variety of options for the placement and movement of a user's hands, for convenience, comfort, efficiency, enhanced functionality, minimization of repetitive stress problems, and the opportunity to experiment with different configurations of input devices. Unlike currently available keyboard products that feature a single, fixed, stationary input device (such as a touchpad, trackball, scroll wheel, tablet, etc.), usually at the base of the keyboard, the present invention allows the user to position one or more input devices and/or platforms in dozens of different places in, on, and around one or more keyboard devices. The systems and methods of the present invention also improve upon aftermarket standalone input devices such as touchpads, since such devices typically have larger housings that make the placement options of the present invention impractical and inefficient.

In some embodiments, one or more input devices (e.g., touchpads, trackballs, scroll wheels, tablets, pointers, etc.) may be moved, rearranged, and/or detached from one or more additional input devices (e.g., keyboards, other input devices, etc.) while in use. In other embodiments, one or more input device platforms are attached to a keyboard using plates that fit in between keys. In preferred embodiments, the plate(s) and/or platform(s) are hinged, slideable, and/or movable to allow the platform and the supported input device to be rotated, slid, and/or moved into a different position (e.g., for ergonomic reasons, or to allow access to keys underneath). In some embodiments, one or more mechanisms such as drawer slides, swiveling or rolling mechanisms, or rotating mechanism (e.g., lazy susans) are used to attach one or more platforms to a keyboard. In preferred embodiments, such moveable platforms have a means or mechanism for preventing movements or locking them in place, thus keeping the platforms in a stationary position unless movement or repositioning is desired. In particularly preferred embodiments, the platforms have a locking means or mechanism that is easily engaged and/or disengaged (e.g., by applying pressure, pressing a button, activating a switch, bending a ridge between keys, etc.). In some embodiments, a cushioning means (e.g., one or more pads, etc.) are positioned to cushion an input device or platform as it is repositioned, so as to prevent damage to the input device, platform, keyboard housing, and/or any associated equipment. In some embodiments, one or more input devices and/or one or more platforms are built into a keyboard housing. In preferred embodiments, a wrist rest may be integrated into an input device, a platform, or a keyboard housing.

In some embodiments, a curved portion of a platform loops under the keys on a keyboard to secure the platform. In other embodiments, the shape of the platform and/or the supported input device is curved, rounded, or otherwise shaped to facilitate the motion of a user's finger(s) sliding underneath to easily reposition the platform and/or input device. In some embodiments, the platform is constructed of elastic or bendable materials in order to provide more flexibility in placement and movement. In other embodiments, the platform is able to function without inhibiting usage of the keyboard. In some embodiments, a pressure activated system is used to attach, release, reposition, or otherwise move the platform. In yet other embodiments, the size and shape of the platform may be adjustable. This allows, for example, the platform to straddle or be positioned on different surfaces or keyboards that have different shapes, differently spaced key rows, or different buttons for various media or scrolling functions. In some embodiments, the platform has adjustments or sections that extend or retract vertically and/or horizontally. In some embodiments, different platforms may be optimized for use with different keyboards.

In some embodiments, an input device and/or a platform are attached with brackets, hinges, tape, glue, tacks, screws, Velcro, or other adhesive material or device to a surface (e.g., back, front, sides, top, bottom, etc.) of a second input device (e.g., a keyboard). In other embodiments, the input device and/or platform are attached with Velcro and made to be stationary on any available space. In some embodiments, the input device and/or platform are fastened permanently (e.g., via glue, etc.). In some embodiments, the input device and/or platform has a fixed or detachable pad (e.g., foam) on its underside, to help prevent undesired movement while in use. In other embodiments, an input device and/or platform are attached with an adjustable mechanism such as a boom arm. In yet other embodiments, an input device and/or platform are attached via a surface material inserted through the hinge between a laptop computer and its screen portion. The surface material may be secured to the laptop computer to prevent movement.

In some embodiments, one or more platforms may be positioned on, in, and/or around one or more keyboard housings and/or other input devices to allow items other than input devices to be placed within easy reach of the user. This arrangement enhances the overall ergonomic efficiency and convenience of the user experience. In other embodiments, the platform, input device, and/or keyboard housing are configured to accommodate storage, routing, connection, and repositioning of cables and/or cords. In yet other embodiments, the platform has a means or mechanism for connecting it to one or more additional platforms, to expand the surface area available to the user.

In some embodiments, a computer monitor is attached to the device (e.g., an LCD screen). In some embodiments, this monitor is retractable. In some embodiments, an image is projected in mid air from the device to act as virtual monitor. In some embodiments, the monitor is worn on the face like eyeglasses. In some embodiments, the monitor is worn on the wrist or leg.

In some embodiments, all functions (e.g., processors, memory, etc.) of a working computer are incorporated allowing device, comprising a self-sufficient computer. In some embodiments of the invention, a PDA or similar device is able to attach and detach to the device.

In some embodiments, the keyboard is programmable, allowing any key configuration including the traditional QWERTY, Dvorak or other known alternatives including non-English languages.

In some embodiments, the keyboard touch pad is made of flexible silicone.

In some embodiments, the keyboard touch pad or other components are made of plastic. In some embodiments the keyboard touch pad is made of fabric or is a virtual keyboard touch pad that is projected.

In some embodiments, a handle allows user to hold both units in one hand when a user move around, stands or make adjustments.

In some embodiments, the device may fit the user's hand securely enough to allow the user to walk, jog, use a treadmill, or carry out other physical movement while in use.

In some embodiments, a strap or band wraps around the user's wrist or hand allowing the user to type and mouse while standing, walking, jogging, using a treadmill, or using other exercise devices.

In some embodiments, handles or straps are positioned around the device allowing the user to easily transport it, position it on their legs, and or hang it up.

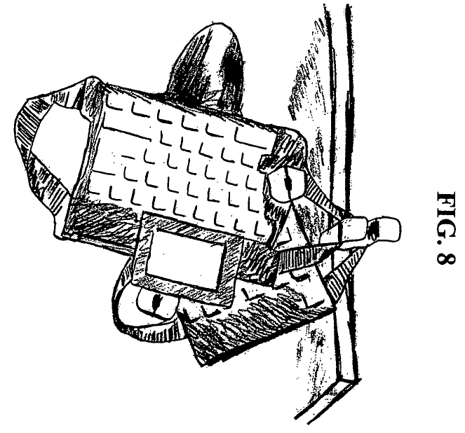

In some embodiments, the devices are hung up on hooks/dowels and or a special stands or similar method of storage when not in use and contain the appropriate straps, hooks, or other attachments to allow such mounting (see e.g., FIG. 8).

In some embodiments, the invention provides a one-handed keyboard mouse combination similar to products like the FROGPAD keyboard (FrogPad™, Inc., Houston, Tex.).

In some embodiments, the device is fitted with novelty cosmetic attachments to give device characteristics of a racecar, airplane, Barbie doll or a cartoon character or other toy to enhance appeal to youngsters.

In some embodiments, a backpack type bag with pockets wraps around the device for carrying and transporting the device.

In some embodiments, special keys that allow the user to not only press down the key but allow the user to move the key at an angle side-to-side or up and down without triggering the letter are used to give a key more functions.

In some embodiments, the underside has wheels or rollers that aid in moving and or holding device in place. These wheels or rollers may be motorized, engaging when in mouse function and disengaging when at rest or being typed on.

In some embodiments, the device is connected to a computer or other device using one or more standard interface protocols such as USB, PS/2, IEEE-1394, serial, parallel, or wireless connections. In other embodiments, the device is connected using any suitable wired or wireless connection protocol.

In some embodiments the device has one or more auxiliary ports (e.g., USB, PS/2, IEEE-1394, serial, parallel, etc.) allowing the user to easily switch components and easily connect auxiliary devices (e.g., flash drives, MP3 players, cameras, etc.). In some embodiments, one or more auxiliary ports use one or more standard interface protocols such as USB, PS/2, IEEE-1394, serial, parallel, or wireless connections (e.g., a wireless repeater or amplifier port). In other embodiments, the auxiliary ports use any suitable wired or wireless connection protocol.

In some embodiments, functions of a telephone, camera, sound player and or recorder may be incorporated into the device.

In some embodiments, the device may be enclosed and or heated to keep safe from outdoor elements.

In some embodiments, a writing tablet is incorporated into the device.

In some embodiments, the device may be used while attached to a chair and be detached for use on legs or desktop. In some embodiments, the device may be stored on the underside of desk or table. In some embodiments, cords that connect to computer may be retractable.

In some embodiments, the device has pockets or pouches to, for example, permit storage of pens, memory cards, etc.

It is to be understood that the devices of the present invention may be configured to work with or integrated with appliances, furniture, musical instruments, toys, shoes, sporting equipment, glassware, vehicles, clothing, etc. Likewise, materials used in the construction of any of the above may also be used in the devices of the present invention.

The systems and devices of the present invention find use in any application where a computer keyboard or other peripheral is used. However, in particularly preferred embodiments, the present invention provides methods for improved ergonomics uses with people, or in situations, where improved ergonomic use is desired. For example, the devices of the invention are very useful to people who work in environments that have temporary furniture, like card tables or display tables (e.g., convention or production companies on location). Temporary office help that is constantly made to use different furniture will find the devices of the present invention particularly useful. The invention also finds particular use by police officers, pilots, or other persons who use a computer in a vehicle.

### DETAILED DESCRIPTION OF THE INVENTION

Certain preferred embodiments of the invention are shown in the attached drawings and described below. It should be understood that the present invention is not limited to these particular embodiments.

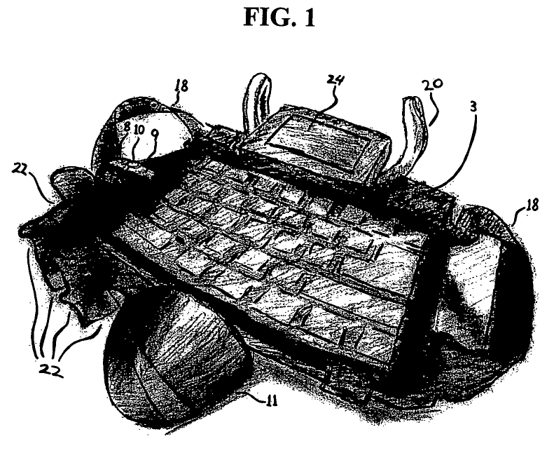

The computer data input invention in an embodiment show in FIG. 1 comprises a component configured to engage a hand, wrist, or arm and permit the hand, wrist, or arm to move the device. When using a mouse that is integrated into the device, the hand may naturally rest in this position when typing or resting. The keyboard keys (3) are configured for ease of reach by a single hand. In this embodiment, two buttons (8 and 9) provide left and right mouse click functionality, although any number of mouse click buttons may be provided. Mouse functions may also be provided on other portions of the device. For example, component (10) provides a scroll wheel. A housing (11) is provided for the mouse components and/or other electronic and/or mechanical components for all functions of device, including retractable anchoring. The hand can rest on this housing when guiding the mouse. Straps (18) are positioned around the device, allowing the user to easily transport it, position it on a leg, and or hang it on a hook, clamp, dowel, or other anchoring method. An anchoring mechanism (20) anchors or grips the device to a leg or other surface. This form may be hinged or made in such a way that it can be disengaged easily in order to allow the device free movement. A grip (22) with several different openings, slots, grooves, and/or holes that allow the user's hand to move the device and control the mousing or pointing operation from different positions/angles is provided. A touchpad (24) is also provided.

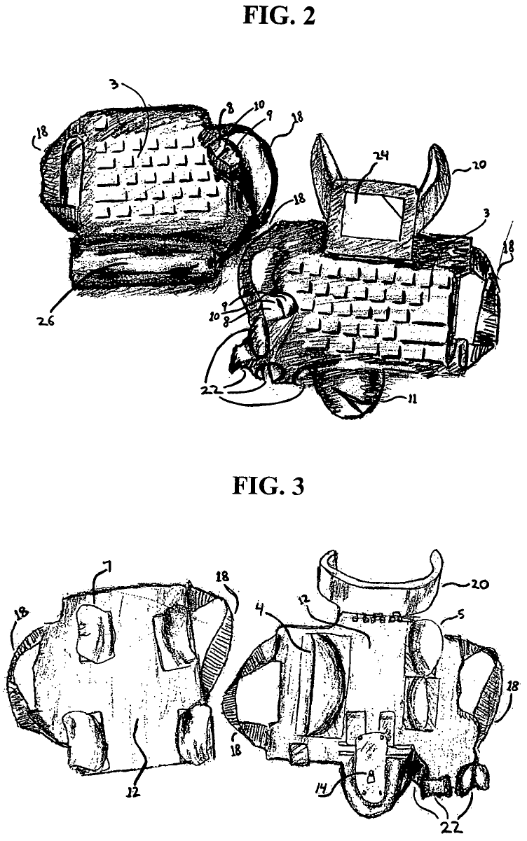

FIG. 2 shows the left and right hand portions of the embodiment shown in FIG. 1. Duplicate or redundant data input controls may be provided on both portions of the devices, such as mouse click buttons (8 and 9) and/or a scroll wheel (10). A palm or hand rest (26) is also provided.

FIG. 3 shows the underside of the embodiment of the device shown in FIGS. 1 and 2. The underside of the device has right and left edges (4 and 5) shaped to allow easy placement on a leg while being smooth with rounded edges for easy movement (e.g., to enable sliding along the length of the leg). The left or right hand portions of the device may also feature forms (7) made from or covered with a non-smooth material that creates friction when moved, thereby preventing the device from being easily moved (e.g., for secure attachment to a surface such as a user's leg). Sections of Velcro or other attachable material (12) are used as method of attaching these forms and allowing adjustment. A movement sensor or LED (14) is used for mouse function.

FIG. 4 shows a profile of a user with device in use in some embodiments of the present invention. The body position shown is recognized by the Cornell University Ergonomics Department as being an “ideal typing position.”

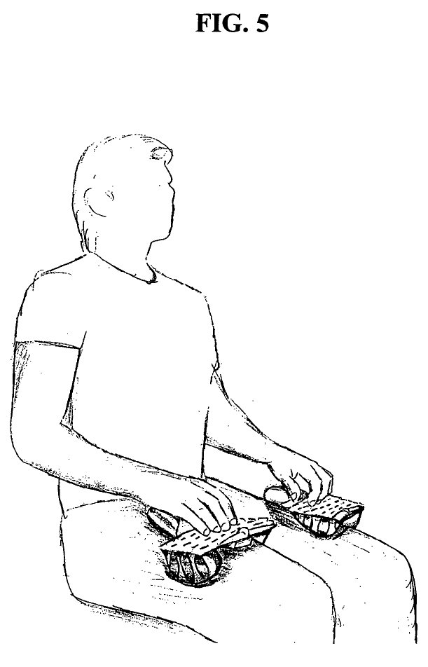

FIG. 5 shows split keyboard components with left and right hand units in use in some embodiments of the present invention.

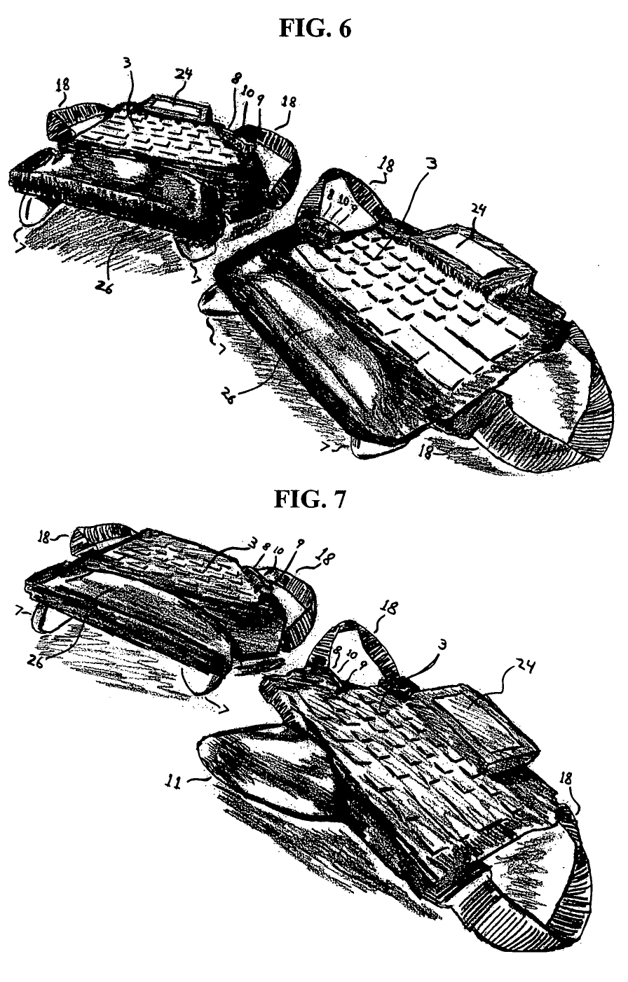

FIG. 6 shows split keyboard components with left and right hand units in use in some embodiments of the present invention.

FIG. 7 shows split keyboard components with left and right hand units in use in some embodiments of the present invention.

FIG. 8 shows the invention suspended from a hook for storage purposes.

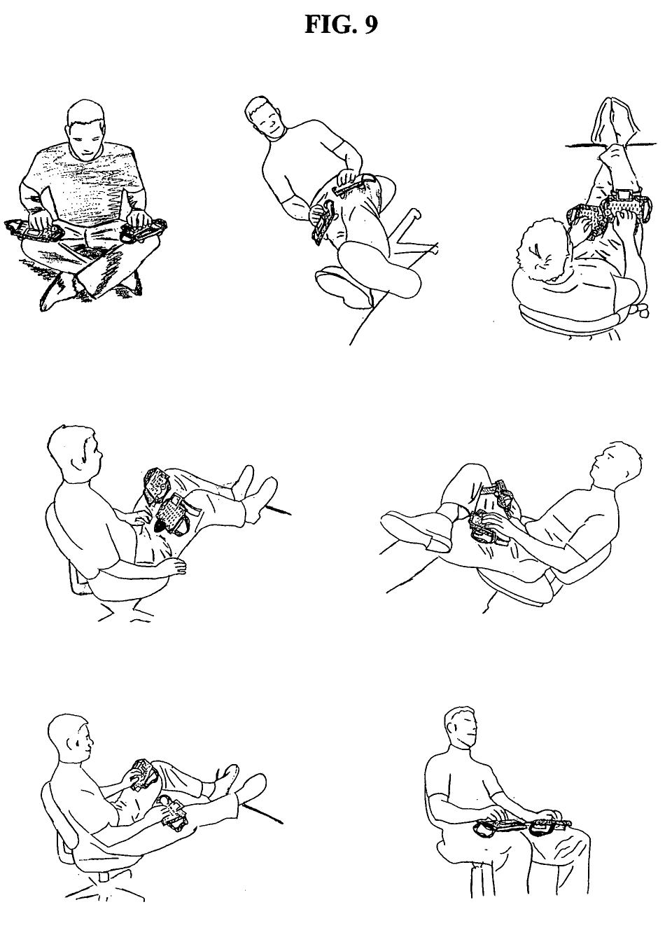

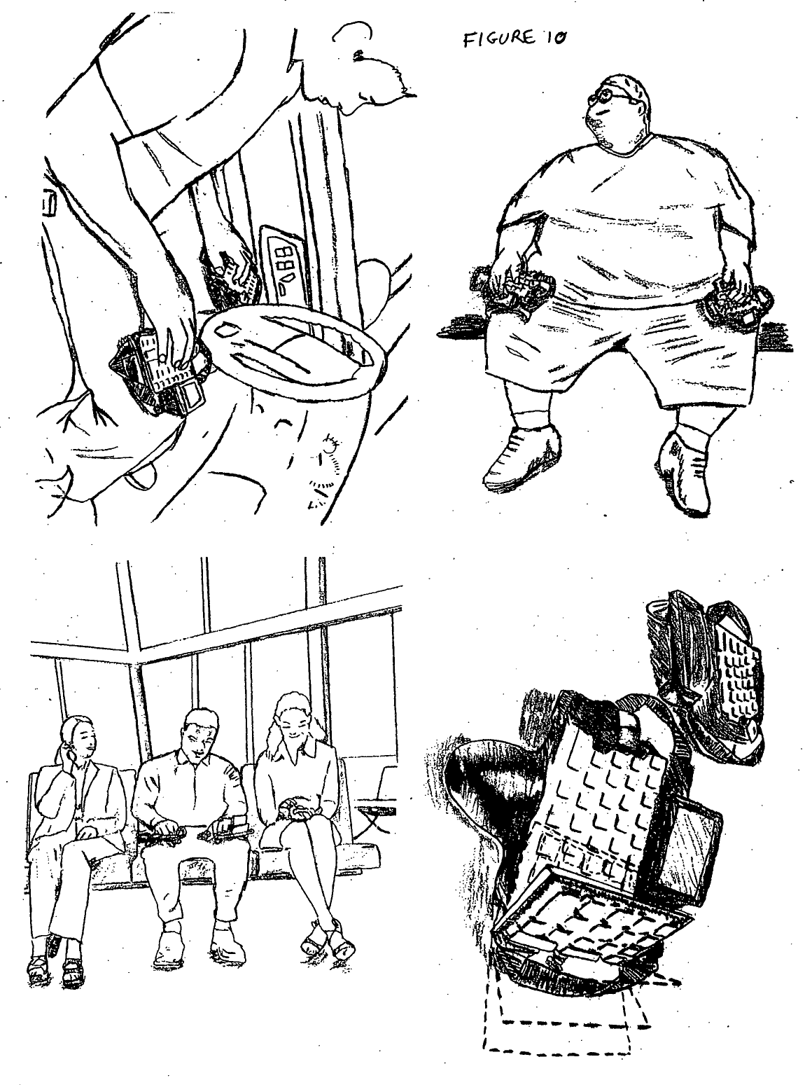

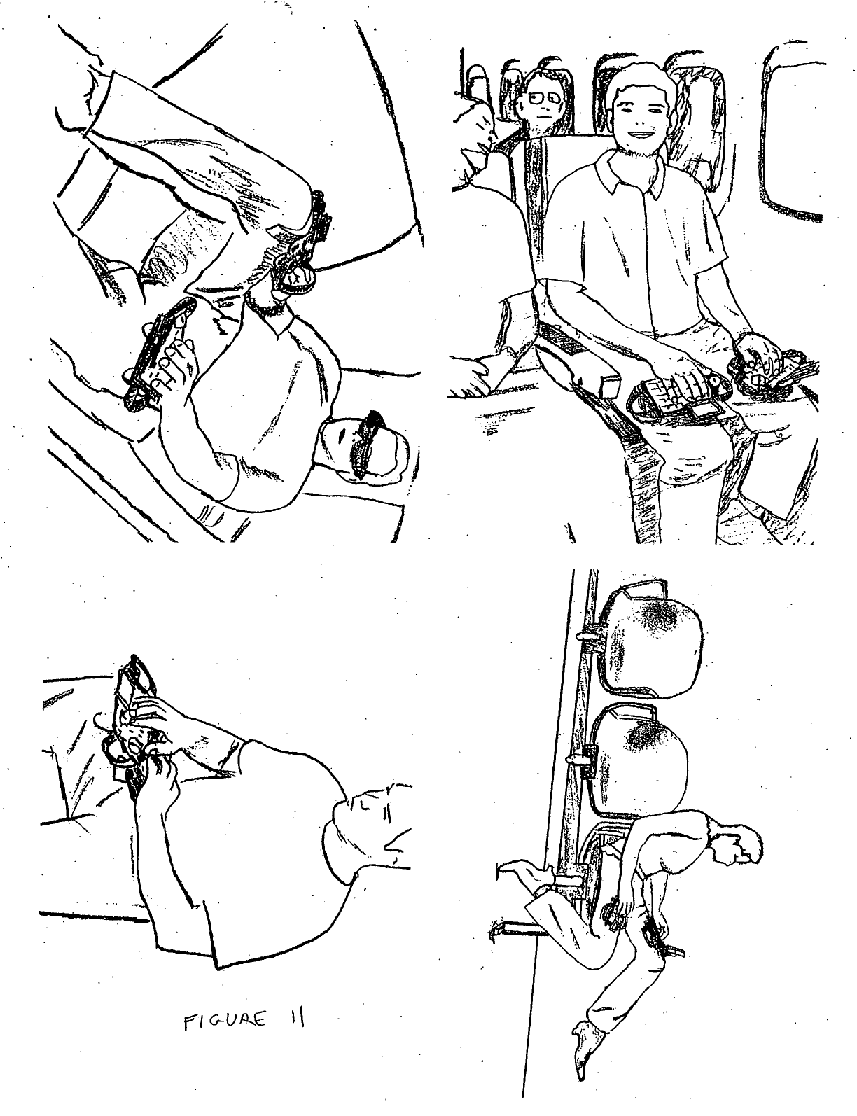

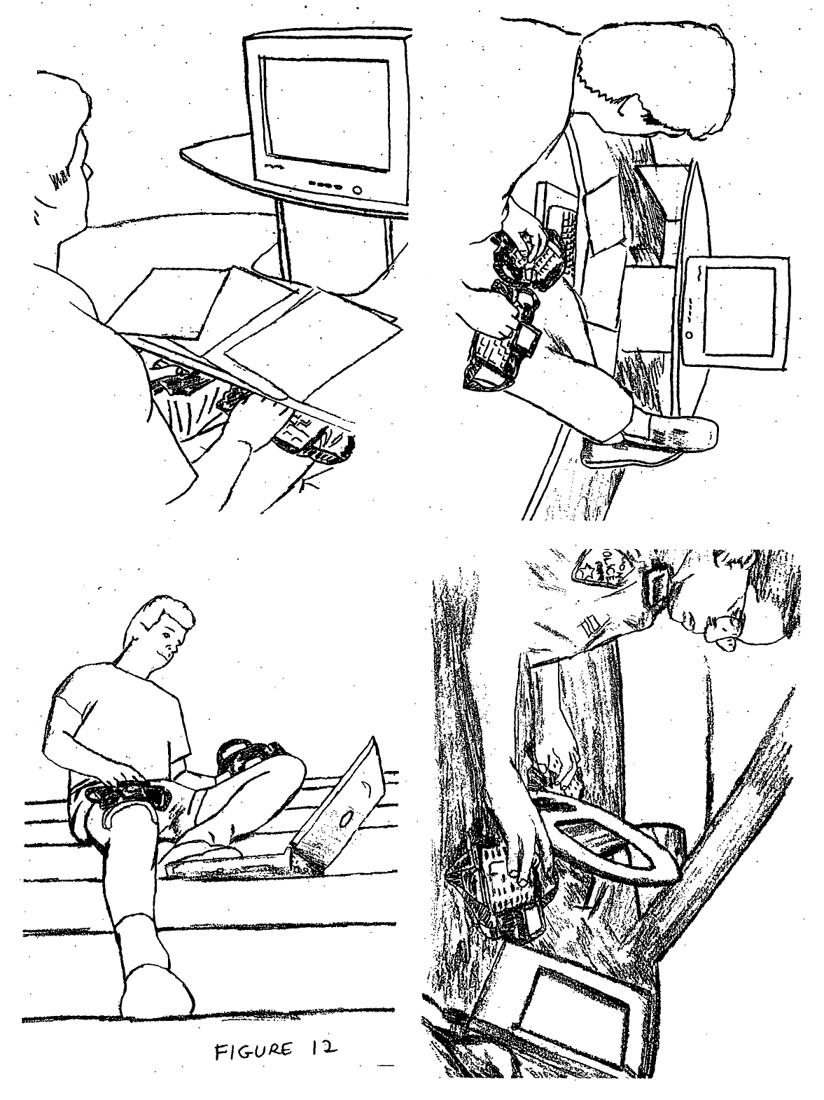

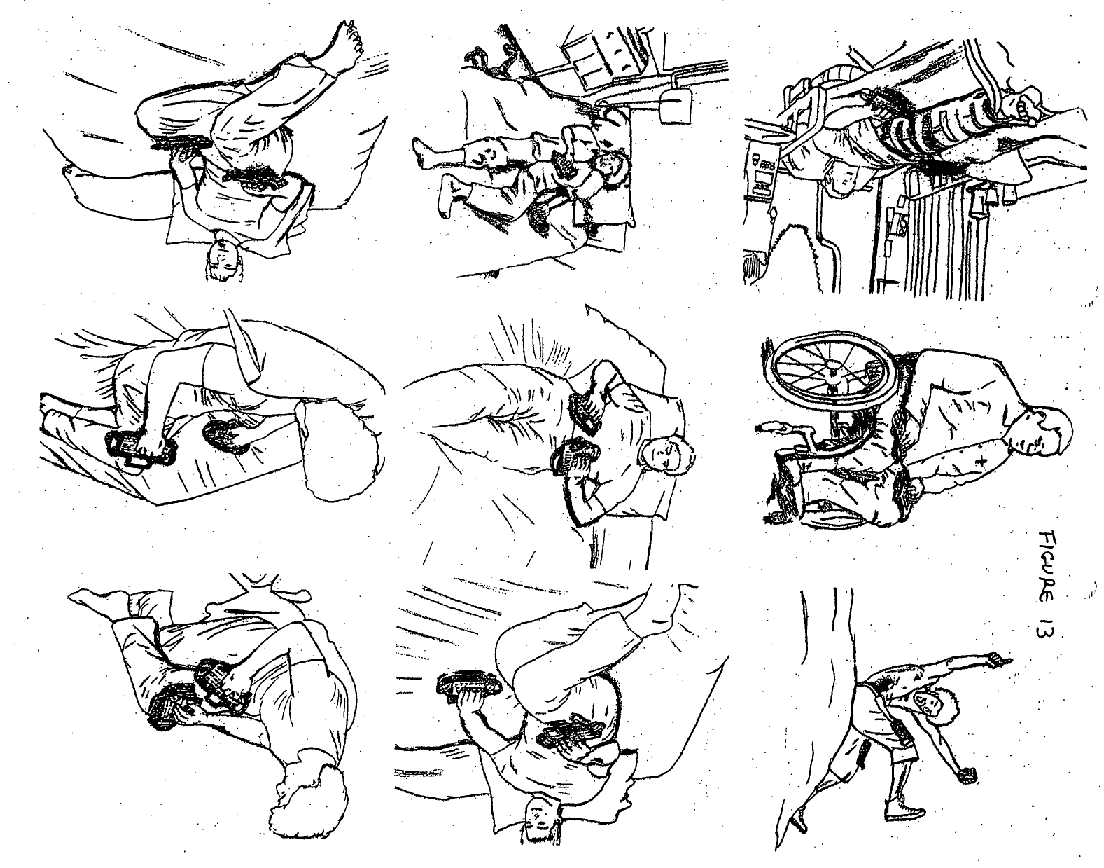

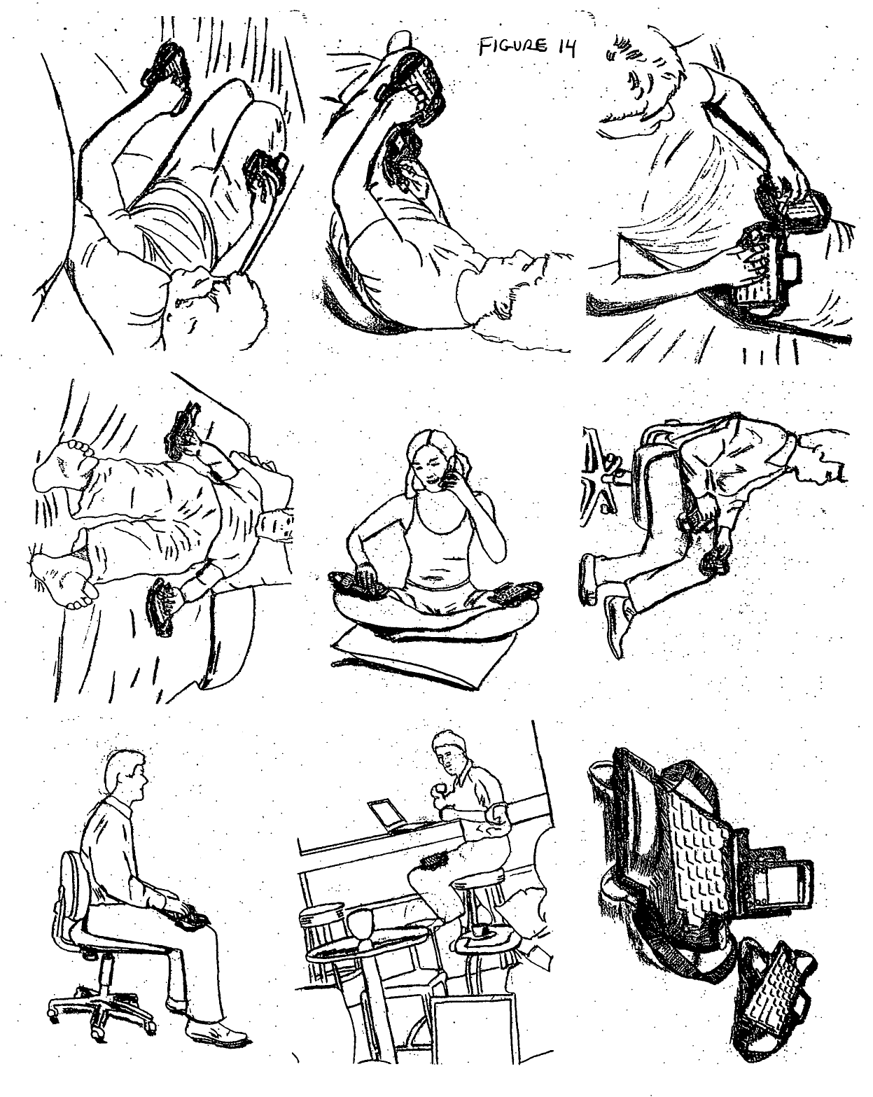

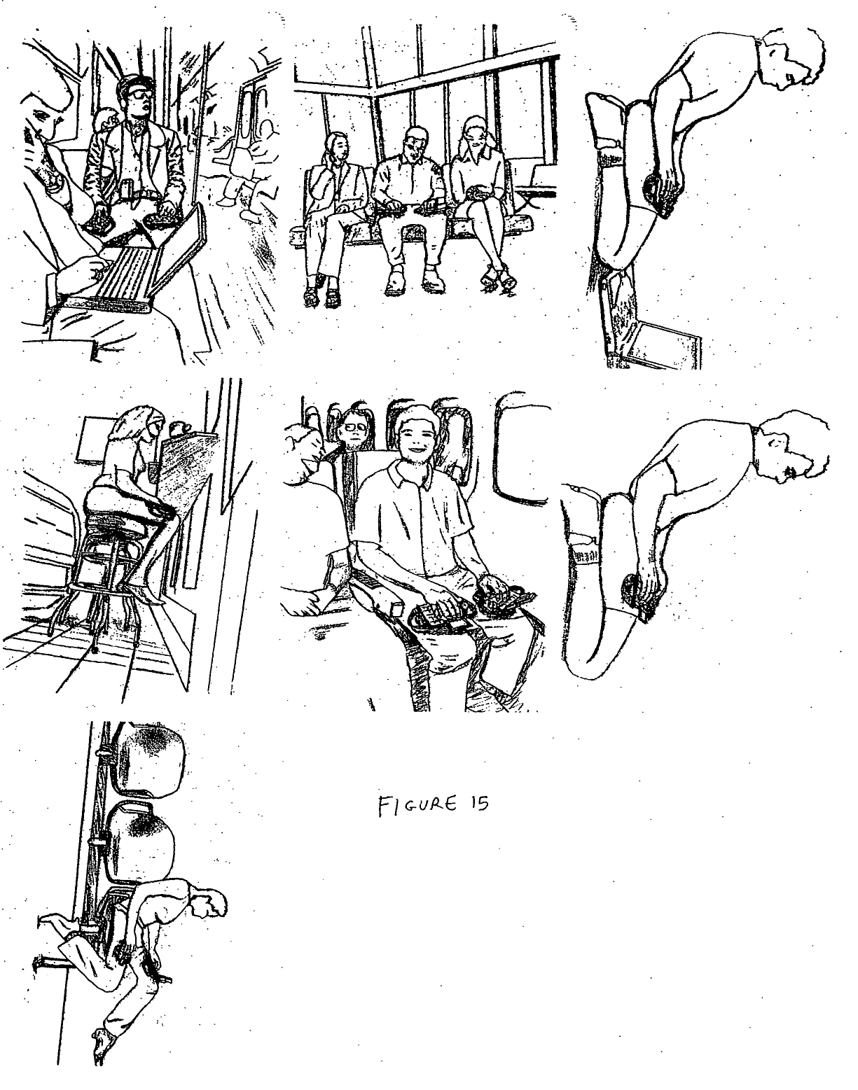

FIGS. 9-15 illustrate various embodiments of the invention in use showing different body positions and environments accommodated by the keyboards in some embodiments of the present invention.

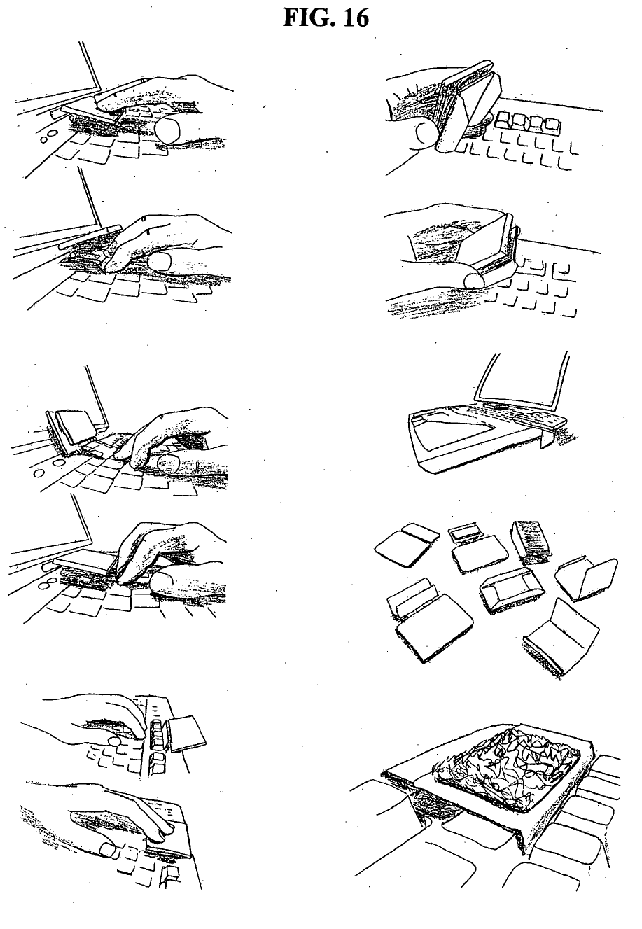

FIG. 16 shows input device platforms in use in various embodiments of the present invention.

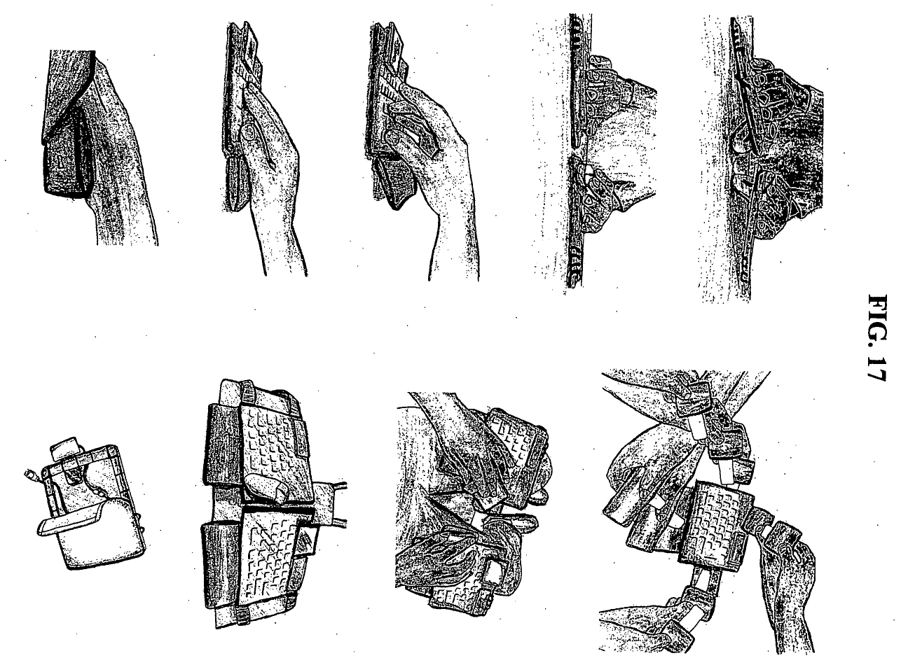

FIG. 17 shows input device platforms, wrist rests, and cable management systems in use in various embodiments of the present invention.

It is understood that the examples and embodiments described herein are for illustrative purposes only and that various modifications or changes in light thereof will be suggested to persons skilled in the art and are to be included within the spirit and purview of the present invention.

We claim:

1. A keyboard system comprising first and second keyboard components, each of said first and second keyboard components containing a portion of a full keyboard, wherein each of said keyboard components further comprises an undercarriage configured for positioning on a human leg and configured for lateral sliding movement along the length of the leg, wherein each of said keyboard components further comprises a component for engaging a hand, wrist, or arm to permit said hand, wrist, or arm, to move said device along at least said length of said leg.

2. The keyboard system of claim 1, wherein said undercarriage comprises first and second forms, collectively configured to grip said leg.

3. The keyboard system of claim 1, wherein said first and second forms are made of a material that permits said device to slide along said leg.

4. The keyboard system of claim 1, wherein said system further comprises a locking component attached at one end to at least one of said first and second keyboard components and at the other end to body part of clothing of the user so as to restrict the range of lateral motion said keyboard system can undergo along said length of said leg.

5. The keyboard system of claim 1, wherein said component for engaging a hand, wrist, or arm comprises two non-connecting raised edges that contact the sides of said hand, wrist, or arm without restricting said hand, wrist, or arm from freely disengaging the keyboard system.

6. The keyboard system of claim 1, wherein one or more of said first or second keyboard components further comprises a component that provides mouse functionality.
